(19) United States
(12) Patent Application Publication
(10) Pub. No.: US 2003/0180537 A1
(43) Pub. Date: Sep. 25, 2003

(54) Spheroidal particles and apparatus and process for producing same

(75) Inventor: Paul W. Meyer, Minneapolis, MN (US)

Correspondence Address: Paul W. Meyer, BLACK DIAMOND GRANULES, INC., 499 Cottage Grove Drive, Woodbury, MN, 55129, US

(73) Assignee: Black Diamond Granules, Inc., Woodbury, MN

(21) Appl. No.: 10/305,864

(22) Filed: Nov. 26, 2002

Related U.S. Application Data
(62) Division of application No. 09/691,349, filed on Oct. 17, 2000, now abandoned.
Application No. 09/691,349 is a continuation-in-part of application No. 09/016,707, filed on Jan. 30, 1998, now Pat. No. 6,258,456.

(51) Int. Cl. B32B 5/16

(52) U.S. Cl. 428/404; 428/403

(57) ABSTRACT

The present invention provides spheroidal particles from slag and ash. The spheroidal particles are formed by dropping particles of slag and ash through a heated zone which fuses at least an outer surface of the particles.

### RELATED APPLICATION

This application is a continuation-in-part of U.S. patent application Ser. No. 09/016,707, filed Jan. 30, 1998, incorporated herein by reference.

### FIELD OF THE INVENTION

The present invention relates to processes for spherulizing slag and ash particles, apparatuses suitable for carrying out the processes, and the spheroidal particles so produced.

### BACKGROUND OF THE INVENTION

Each year many tons of materials such as slag and fly ash resulting from combustion of coal in boilers, hereinafter referred to as coal slag and coal fly ash, found in electric generating plants are produced. In the United States in 1993, for example, over 5.6 million metric tons of coal slag and 43.7 million metric tons of coal fly ash were produced as coal combustion byproducts. Other sources of similar waste include waste incinerators. The greatest use of such materials is found in roofing granules and as sandblasting materials. Other uses are found in cement and concrete products, snow and ice control, and grouting materials. However, only about 55% of the coal slag and only about 22% of the coal fly ash is incorporated into useful products. The remaining amount is generally disposed of in landfills.

The need to provide additional useful products from such materials and thereby alleviate disposal of these materials in waste storage landfills has long been felt. Forming coal slag or coal fly ash into useful products is considered to be a significant improvement over disposing of such materials in such landfills.

A method for manufacturing rounded vitreous beads is known wherein a feed means which can include a reservoir adapted to hold a fluidized bed of feedstock particles and having at least one overflow under gravity. For manufacture of solid beads, crushed glass cullet is the recommended feedstock for cellular beads, a pelletized feedstock containing glass formers and cellulating agent is recommended. The feedstock is delivered to the upper end of a chamber which includes a pair of opposed walls which are spaced apart by a distance less than their breadth, e.g., 15-30 cm, and which are angled to the horizontal so that the feedstock can pass through the chamber under gravity.

In this method, a means for heating the chamber is arranged to heat at least one wall of the pair of opposed walls so that feedstock passing between the pair of opposed walls is heated by radiant heat. The chamber can have segments of increased spacing between the opposed walls from the top of the chamber to the bottom of the chamber as well as differing temperatures in different zones downward through the chamber. For some feedstock compositions, it is desirable to allow the particles to expand while subjected to a temperature in the range of 400° C. to 500° C., to heat the particles to 800° C. to 900° C. for spherulization, and to heat them to about 1200° C. for partial devitrification.

A process has also been disclosed for producing ceramic powders based on single- or multi-phase metal oxides, including SiO₂ compounds, exhibiting a narrow particle size distribution. The raw feed material exhibits a specific surface area of 0.05 up to 500 m²/g and is treated in an indirectly heated drop tube furnace in the form of classified granules exhibiting an average diameter of 10 to 2500 μm for a period of 0.5 up to 15 seconds at a temperature of 500° K. up to 3500° K. The raw feed material flows freely into the furnace via a charging device and drops by action of gravity, in a quasi free-falling manner, through the furnace atmosphere, which is oxidizing, inert or reducing, and is cooled. The cooled-off discharged reaction sintered agglomerates are collected and deagglomerated into primary particles using of an ultrasonic milling device, a sand mill or a jet mill to produce ceramic powder.

Spheroidal particulate material, such as spheroidal cement or smelter slag, can be produced by subjecting the particles to a high temperature flame treatment and rapidly cooling them in air. A retention furnace for retaining a molten liquid inorganic material and a nozzle assembly communicated to the retention furnace and capable of scattering therethrough the molten liquid inorganic material are provided. A jet gas entrains the molten inorganic material introduced in the nozzle assembly and scatters the molten inorganic material to cool it. Gas spray devices for spraying the jet gas are also provided.

### SUMMARY OF THE INVENTION

The present invention, in one aspect, provides spheroidal particles of slag (e.g., coal slag) and ash (e.g., coal fly ash or incinerator ash). The spheroidal particles have at least a hard outer shell, a diameter preferably in the range of about 0.001 to 5 mm, more preferably in the range of about 0.1 to 1 mm, and comprise SiO₂, Al₂O₃, and CaO. Components can also include other oxides such as, for example, oxides of heavy metals, and other materials. In some embodiments, the spheroidal particles have an aspect ratio of no more than 1.4 or 1.2.

The spheroidal particles of coal slag of this invention can have high hardness due to the relatively high amounts of Al₂O₃. This high hardness allows the spheroidal particles to be used, for example, as shot-peening media. The spheroidal shape of the coal slag particles provides low interparticle friction and a low angle of repose, which enables the particles to be used, for example, as fillers for lubricants or plastic resins, or as flowable construction fill. The spheroidal fly ash particles can be resistant to leaching of constituent oxides by water due to the reduction in porosity and surface area that occurs on spherulization. These spheroidal fly ash particles can also be resistant to hydrolysis due to the relatively low proportions of alkali metals, i.e., Na₂O and K₂O, and relatively high proportions of CaO and Al₂O₃, in the particles. This also provides resistance to leaching of constituent oxides by water.

The present invention, in another aspect, provides a process for spherulizing irregularly shaped particles of coal slag or agglomerated coal fly ash, resulting from coal combustion. The process includes the steps of:

(a) providing a drop tube having an upper portion, a central portion and a lower portion;

(b) delivering a feedstock of irregularly shaped particles of slag or ash to the upper portion of the drop tube in a manner such that the particles flow in a substantially vertical downward path through the feed tube as individualized particles;

(c) heating the particles to a sufficient temperature by providing heat to the outer surface of the central portion of the drop tube to cause at least the outer surface of the particles to melt such that a majority, i.e., at least about 50 weight percent, of the particles become spheroidal due to surface tension at the outer surface; and

(d) cooling the particles, preferably in the lower portion of the drop tube, to prevent agglomeration.

The slag or ash feedstock, which can range in size from, for example, about 0.001 to 10 mm, preferably from about 0.1 to 1 mm, can be delivered through a feed tube having a discharge port, having one or more holes, each with a diameter from, for example, at least the maximum particle diameter of the feedstock, and more preferably, at least one to twenty times the maximum particle diameter of the feedstock, at the lower end thereof.

The present invention, in a further aspect, provides an apparatus for spherulizing particles comprising

(a) a substantially vertical elongate drop tube;

(b) a feed tube extending into the upper terminal portion of the drop tube and having a substantially closed lower terminal portion with a discharge port therein, the vertical axis of the discharge port being substantially on the vertical axis of the drop tube;

(c) feed device for supplying a feedstock to the feed tube;

(d) vibrating device for intermittently rapping the feed tube to cause discharge of the feedstock from the feed tube in a substantially vertical downward path through the drop tube as individualized particles;

(e) heating device proximate the outer portion of the drop tube and proximate a central portion of the drop tube, the heating means being capable of providing sufficient heat within the drop tube to cause the viscosity of at least the outer portion of the particles to become sufficiently low to allow the surface tension of the particles to spherulize the particles;

(f) cooling device to effect cooling of the spherulized particles such that the particles do not adhere to each other; and

(g) device for collecting the spherulized particles.

The apparatus of the invention is particularly useful with particles having irregular shapes such as, for example, slag or ash. The vibrating device can be provided by a magnet and coil, the coil being intermittently powered to cause the magnet to rap the feed tube, or by a solenoid. The feedstock can be provided to the feed tube, for example, by gravity. The heat can be provided, for example, by a radiant heater, by an electric heating element or gas fired or particle burning heating elements encircling the drop tube, by convection heat such as provided by, for example, direct flame or preheated air, or by induction or dielectric heating of the drop tube and/or the feedstock. A fan can be provided adjacent the lower end of the drop tube, if necessary, to provide suction pressure to overcome any chimney effect caused by heating the central portion of the drop tube.

The present invention, in another aspect, provides a feed system for feeding irregularly shaped particles comprising:

(a) a feed tube oriented substantially vertically and having a substantially closed lower terminal portion with a discharge port therein;

(b) feed device for supplying a feedstock of irregularly shaped particles to the feed tube; and

(c) vibrating device for intermittently rapping the feed tube to cause discharge of the feedstock from the feed tube in a substantially vertical downward path as individualized particles.

The present invention, in another aspect, provides a process for feeding irregularly shaped particles comprising:

(a) feeding irregularly shaped particles to a feed tube oriented substantially vertically and having a substantially closed lower terminal portion with a discharge port substantially centered on the vertical axis of the feed tube;

(b) intermittently rapping the feed tube to cause the particles to discharge from the feed tube in a substantially vertical downward path and at a rate at which the particles remain individualized.

Another embodiment is a method of processing particles comprising slag or ash. Particles of slag or ash are delivered to an inlet of a drop tube furnace. The particles are dropped through the drop tube furnace. The particles are heated as the particles traverse through a heating portion of the drop tube furnace to melt at least an outer surface of the particles such that a majority of the particles become substantially spheroidal. The particles are cooled as the particles traverse through a cooling portion of the drop tube furnace to deter agglomeration when collected.

Yet another embodiment is an apparatus for processing particles of slag or ash. The apparatus includes:

(a) a delivery system to deliver the particles for heating;

(b) a drop tube configured and arranged so that the particles from the delivery system drop through the drop tube;

(c) at least one heating element disposed proximate the drop tube to heat the particles dropping through the drop tube, the at least one heating element being configured and arranged to heat the particles to a temperature where the particles form spheres;

(d) an outlet duct coupled to the drop tube to receive particles from the drop tube, the outlet duct retaining a substantial amount of heat from the drop tube; and

(e) a cooling zone to receive particles from the outlet duct and configured and arranged to allow the particles to cool prior to collection to reduce agglomeration of the particles.

### BRIEF DESCRIPTION OF THE DRAWINGS

FIG. 1 is a cross-sectional side view of an apparatus useful in the process of the present invention.

FIG. 2 is an enlarged cross-sectional view of the delivery system of the apparatus shown in FIG. 1.

FIG. 3 is a cross-sectional view of an alternative feed mechanism useful with the apparatus of the invention.

FIG. 4 is photomicrograph produced using a scanning electron microscope (SEM) of a coal slag feedstock used in Example 1 at a magnification of 27×.

FIG. 5 is an SEM photomicrograph of a spheroidal coal slag product prepared in Example 1 at a magnification of 27×.

FIG. 6 is an SEM photomicrograph of a coal fly ash feedstock used in Example 2 at a magnification of 27×.

FIG. 7 is an SEM photomicrograph of a spheroidal coal fly ash product prepared in Example 2 at a magnification of 27×.

FIG. 8 is a cross-sectional view of a second embodiment of an apparatus useful in the processes of the invention.

FIG. 9 is an expanded cross-sectional view of one embodiment of a delivery system, according to the invention.

FIG. 10 is an expanded cross-sectional view of a second embodiment of a delivery system, according to the invention.

FIG. 11 is an expanded cross-sectional view of a third embodiment of a delivery system, according to the invention.

### DETAILED DESCRIPTION OF THE INVENTION

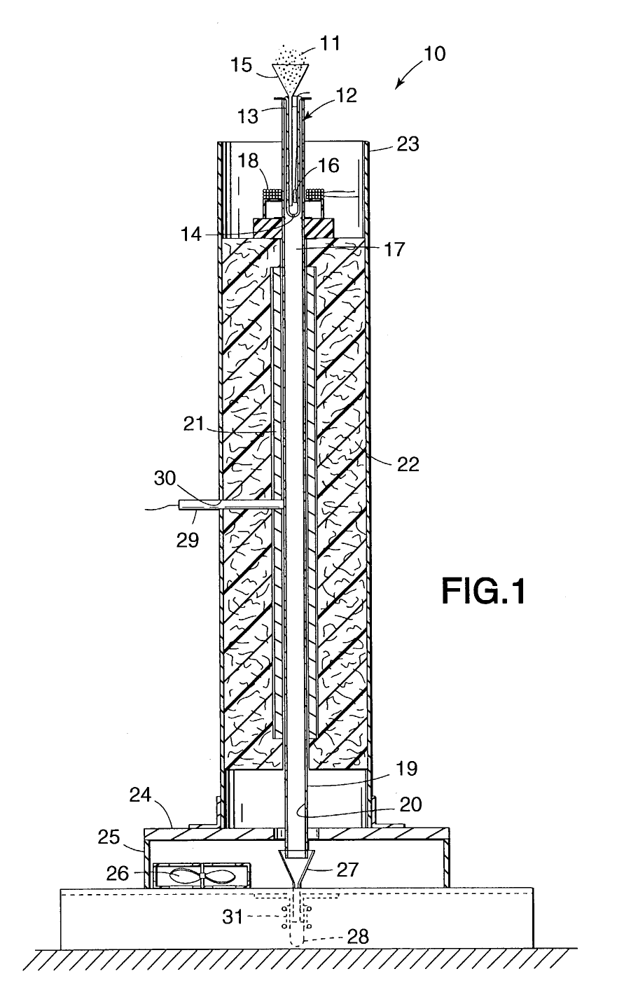

FIG. 1 shows apparatus 10 useful in the present invention. Feedstock 11 which comprises irregularly shaped particles of slag (e.g., coal slag) or ash (e.g., agglomerated coal fly ash or incinerator ash) delivered by delivery system 12 which includes feed tube 13 having a discharge port 14, at the bottom thereof. Feedstock can be fed into feed tube 13 by use of a gravity feed utilizing, for example, funnel 15 as shown.

Feed tube 13 can be formed from various materials including, but not limited to, ceramics such as, for example, borosilicate glass, quartz, silicon carbide or alumina, or refractory metals such as, for example, Inconel 600 or platinum. Feed tube 13 can also be formed from or lined with materials exhibiting low adhesion and/or low coefficient of friction with the feedstock at elevated temperatures, e.g., in the range of about 500° C. to 1000° C. or more, including, but not limited to, refractory ceramics such as, for example, chrome oxide, zirconium oxide, refractory metals such as, for example, platinum or platinum-gold alloy, or refractory materials requiring non-oxidizing atmospheres, such as, for example graphite or boron nitride.

Discharge of feedstock 11 from feed tube 13 can be accomplished, for example, by gravity; intermittent vibration; mechanical scraping, such as a rotary or reciprocating paddle or a feed screw or air or mechanical fluidization with either overflow or underflow, all of which are known to those skilled in the art.

In FIG. 1, an intermittent vibratory device is provided. Magnet 16 is positioned adjacent an inner portion of feed tube 13. As can be seen, feed tube 13 is positioned within an upper portion of drop tube 17 and coil 18, which is connected to a power supply (not shown) and is positioned outwardly of drop tube 17. The power supply intermittently supplies power to coil 18 such that magnet 16 intermittently jars the tube sufficiently, the frequency and force dependent on the particle size, to encourage flow of feedstock 11 through discharge port 14 without blockage thereof.

Discharge port 14 can have, for example, a regular cross-section, such as circular or polygonal, or an elongate cross-section, such as an ellipse or a rectangular slot, or an array of holes, e.g., in a circular pattern. Discharge port 14 can also have, for example, a topology such as an annular slot, i.e., a ring, or an open circle or other various open shapes. Discharge port 14 can also be a bare wire screen or a ceramic coated wire screen, to limit or provide a more uniform flow rate over the cross-section of discharge port 14. Delivery of feedstock 11 is preferably carried out at a rate such that the particles have minimal contact with each other as they flow down the drop tube and, thus, remain individualized without sticking to each other. The delivery of feedstock 11 is also such that substantially all of the particles reach the bottom of the drop tube. The spacing between the lower terminal portion of the funnel stem and the bottom of the feed tube is adjusted such that the depth of the feedstock at the bottom of the feed tube is preferably 1 to 100 particle diameters or more, and most preferably, 1 to 10 particle diameters.

Drop tube 17 is preferably circular in cross-section and can vary in inside diameter from, for example, about 0.01 to 10 meters. Drop tube 17 is preferably oriented substantially vertically and can have a height of from, for example, about 0.01 to 100 meters or more, more preferably about 1 to 50 meters, most preferably about 2 to 20 meters. Generally, the inner wall 20 of drop tube 17 is vertical, although wall 20 can be as much as about 10° inward in the downward direction and perform adequately. Preferably, any angle from the vertical is outward in the downward direction to reduce the rate of impact of particles on inner wall 20.

Drop tube 17 can be of various materials including, for example, ceramics such as fused quartz, aluminum oxide, or silicon carbide, iron-nickel-chromium alloys such as, for example, stainless steel type 304 or 330, Inconel™ 600, or Hastelloy C-276. The inner wall 20 of drop tube 17 can be coated, tiled, or lined with various materials to reduce adhesion between the particles and inner wall 20, and reduce corrosion of inner wall 20 by any liquid slag or fly ash which adheres to inner wall 20. Such coatings include, but are not limited to, chrome oxide, magnesium oxide, zirconium oxide, silicon nitride, silicon carbide, or mixtures thereof, or platinum-gold alloys or, in non-oxidizing atmospheres, graphite or boron nitride.

Drop tube 17 is preferably heated by radiant heat provided, for example, by electric heating element 21 as shown in FIG. 1 or, alternatively, by gas fired or particle burning heating elements, encircling or disposed around the drop tube. Other heat sources, such as, for example, convection heat such as provided by, for example, direct flame or preheated air, or induction or dielectric heating methods can be considered. Generally, the particles drop slowly through the heated zone, preferably having a residence time, for example, from about 0.001 to 100 seconds, more preferably of from about 0.1 to 10 seconds, the residence time required being roughly proportional to the particle diameter.

Preferably, heating element 21 extends along drop tube 17 from a position below discharge port 14 of feed tube 13 for a distance sufficient to heat the vitreous particles to a temperature at which at least the outer surface melts, and the viscosity is sufficiently low to allow the surface tension of the melt to spherulize the particles. For slag and ash particles, the outer surface typically melts at a temperature in the range of about 1000° C. to 1500° C., and the surface tension is about, for example, about 0.2 to 0.5 N/m. Preferably, the temperature at outer wall 19 of drop tube 17 is between about 1000° C. and 1700° C., more preferably between about 1200° C. to 1500° C., as measured by thermocouple 29 inserted through port 30. Heating element 21 does not extend to the lower end of drop tube 17, the unheated portion providing a cooling zone where the spherulized particles can cool to about 500° C. to 1000° C. at which temperature adhesion of the particles does not substantially occur and the particles remain individualized.

Outer wall 19 of drop tube 17 and heating element 21 are preferably encased in insulation 22, at least in the heating zone thereof. Insulation 22 can be, for example, ceramic fiber, hollow ceramic spheres, or refractory brick. Insulation 22 can comprise, for example, ceramic materials such as alumina-silica, alumina, zirconia, silica, magnesia, rock/mineral or glass; or carbon when an inert atmosphere is used; all of which are known in the art. Generally, the insulation can be, for example, about 0.05 to 2 meters in thickness with greater thicknesses typically being used with larger diameter drop tubes.

Insulation 22 is preferably encased in a protective structural shell 23 which aids in supporting the weight of the insulation. Shell 23 can comprise, for example, carbon steel, stainless steel, nickel/chromium alloy, titanium, aluminum, ceramic materials or high temperature-rated plastics. The thickness of the shell wall is not particularly critical, but should be sufficient, where used, to support the insulation, prevent airflow through the shell wall, and to protect the insulation and drop tube from inadvertent impact.

Shell 23 preferably rests on blower box cover 24 on blower box 25. Blower box cover 24 and blower box 25 are constructed to support structural shell 23, heating element 21, drop tube 17, the delivery system and ancillary equipment. An optional exhaust fan 26 can be provided to overcome any chimney effect generated in drop tube 17 by heating element 21.

Within the blower box, a catch basin for catching the spherulized particles is provided. In FIG. 1, the catch basin comprises funnel 27 beneath which sleeve 31 is press-fit into catch tube 28 to prevent air from leaking into the funnel stem. Other catch basins for catching the spherulized particles such as, for example, fluidized beds, conveyor belts, and the like which are known in the art can also be used.

Another example of an apparatus 200 for spherulizing slag and ash particles is schematically illustrated in FIG. 8. Unless otherwise indicated, the same materials, parameters, and design considerations apply to this embodiment as described for the same or similar components in the embodiment illustrated in FIG. 1. The apparatus 200 includes a furnace chamber 202, an outlet duct 204, a cooling zone 206, a catch basin 208, and a delivery system 210. The furnace chamber 202 includes a drop tube 212, one or more heating elements 214, insulation 216, a base assembly 218, and a roof assembly 220.

The drop tube 212 is typically a hollow tube that can have any desired cross-section (e.g., cylindrical, square, rectangular, elliptical, or the like). The drop tube is typically formed of a material that is heat resistant and chemically resistant (or coated with a chemically resistant substance) to reduce or avoid degradation resulting from the heat and slag or ash particles, to inhibit adhesion of the particles, or both. Suitable materials include those discussed above with respect to the drop tube of the apparatus illustrated in FIG. 1. Particularly resistant materials include, for example, nitride-bonded silicon carbide and sintered or chemical vapor deposited silicon carbide.

The heating elements 214 are disposed outside the drop tube 212 to protect the heating elements from the slag and ash particles, however, in some instances, the heating elements can be placed within the drop tube. Preferably, two or more heating elements 214 are used and are positioned symmetrically around the drop tube 212. Any heating element that can produce the desired temperature within the drop tube can be used. The heating elements typically extend along a length of the furnace chamber that is sufficient, for a desired temperature, to achieve the desired spherulization of the particles. Typically, the furnace chamber also includes a temperature sensing device, such as, for example, a thermocouple, that is used to monitor the temperature in the furnace chamber. The thermocouple can be positioned anywhere within the furnace chamber, but is typically near the top of the furnace chamber to provide a measure of the temperature to which the particles are initially exposed and outside the drop tube to protect the device from the slag and ash particles.

Generally, the drop tube 212 and heating elements 214 are surrounded by one or more layers of insulation 216. Insulation 216 can also be provided over the base assembly 218. The insulation 216 can be selected from any material, including ceramic materials (e.g., ceramic fiber materials or hollow ceramic spheres) or refractory materials, as described above, that is suitable for the desired operating temperatures and is, preferably, suitable for temperatures substantially above the operating temperature for safety considerations. The insulation can be layered to provide the highest temperature protection near the heating elements and lower temperature materials further away from the heating elements. The insulation is typically contained within a shell, as described above.

The base assembly 218 can be used to hold the furnace chamber (or all or a portion of the apparatus 200) or can be used simply to close the furnace chamber or provide temperature protection or reduce heat loss through the bottom of the furnace chamber. In addition, the roof assembly 220 is used to close the furnace chamber and typically includes one or layers of heat resistant materials (e.g., ceramic disks) that are substantially resistant to heat conduction to protect, for example, the delivery system from the heat generated in the furnace chamber.

The outlet duct 204 can include a duct channel 222, insulation 224, and a base assembly 226. The duct channel 222 is made of a heat resistant material, e.g., a ceramic or metal material. Preferably, the material of the duct channel 222 is selected to radiate heat back into the furnace chamber, thereby reducing the amount of heat lost from the device. The material is also typically selected to resist adhesion or corrosion (or both) by the slag and ash particles. Suitable materials for reradiating heat include, for example, many ceramics, metals, and alloys. One example of a particularly suitable material is alumina-zirconia-silica ceramic such as the material used to line glass melting tanks. Insulation 224 is typically provided around the outlet duct for protection and to reduce heat loss. The insulation is typically contained within a shell. The base assembly 226 can be used to hold the outlet duct or other portions of the apparatus 200.

The cooling zone 206 optionally includes a tube 228 that conducts the particles at least part of the way from the outlet duct 204 to the catch basin 208. The tube of the cooling zone is typically suspended from the outlet duct to reduce heat transfer from the outlet duct to the material of the cooling zone. Typically, the tube is made of a metal material, such as, for example, steel or aluminum. Alternatively, the cooling zone instead allows the particles to fall through the open air. Generally, the lengths of the cooling zone 206 and outlet duct 204 are selected to sufficiently cool the particles to prevent or reduce agglomeration within the catch basin 208, as described above.

With respect to the catch basin 208, any structure can be used including those described above for the embodiment illustrated in FIG. 1. One suitable example is a metal or ceramic bowl or container.

A variety of delivery systems can be used, including any of those described above. The delivery system 210 illustrated in FIG. 8 includes a tube 230 around the remainder of the components, a funnel 232 into which the particles are placed or directed, and a crucible 234 or other holder having an opening 236 through which the particles are provided to the furnace chamber 202.

The tube 230 can be made of any material that helps to protect the components within the delivery system 210 from heat and damage. In some embodiments, the intermittent vibratory device (containing magnets) described above taps the upper rim or other portion of the tube 230 to direct the particles through the opening 236. In these embodiments, the tube 230 is made using a material that can withstand the vibrations.

The funnel can be made of any material that is suitable for carrying the ash or slag including, for example, glass, ceramic, or metal. The crucible can also be made of such materials, particularly materials that are resistant to the heat transmitted from the furnace chamber 202. Preferably, the crucible has good thermal conductivity to act as a heat sink and reduce or prevent overheating of the feedstock or opening 236.

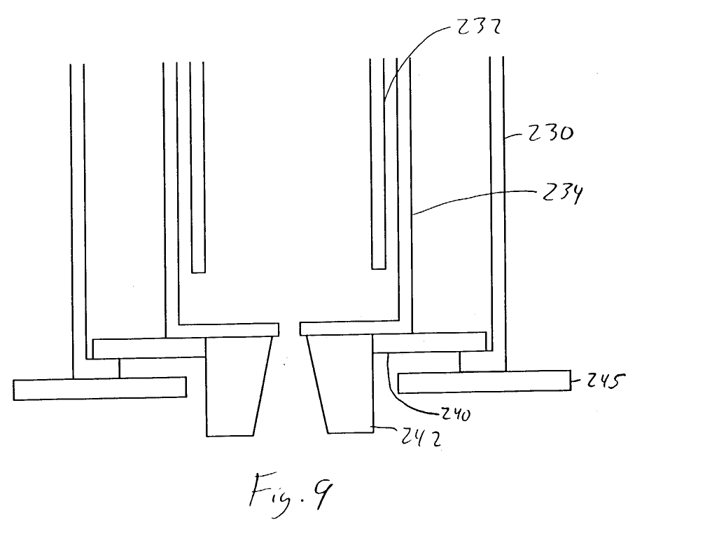

A close-up schematic view of a delivery region of one embodiment is illustrated in FIG. 9. In this embodiment, a support disk 240 made of a heat resistant material, such as a ceramic material, is positioned within and disposed on a lip of the tube 230 and the crucible 234 is positioned on the support disk 240. Both the support disk 240 and crucible 234 have openings that allow the particles to escape into the furnace chamber. In addition, the delivery system includes a gasket 245 and insulating plug 242 to prevent or reduce heating of the crucible 234 that fits into the opening of the furnace chamber. The gasket 245 prevents or reduces air leakage between the furnace chamber and the delivery system. Preferably, the gasket 245 is made using a ceramic fiber material. Air leakage can produce a chimney effect which causes the slag or ash particles to fly around and coat the interior of the furnace chamber or the delivery system and possibly plug the delivery system.

The delivery system preferably allows the particles of slag or ash to fall into the furnace chamber with little or no horizontal velocity. Thus, the particles preferably fall relatively vertically through the apparatus. The opening 236 in the crucible 234 restricts the flow rate and horizontal velocity of the particles. The vibrations made using the intermittent vibratory device are typically restrained so that they do not induce substantial horizontal velocity in the particles that they dislodge through the opening 236.

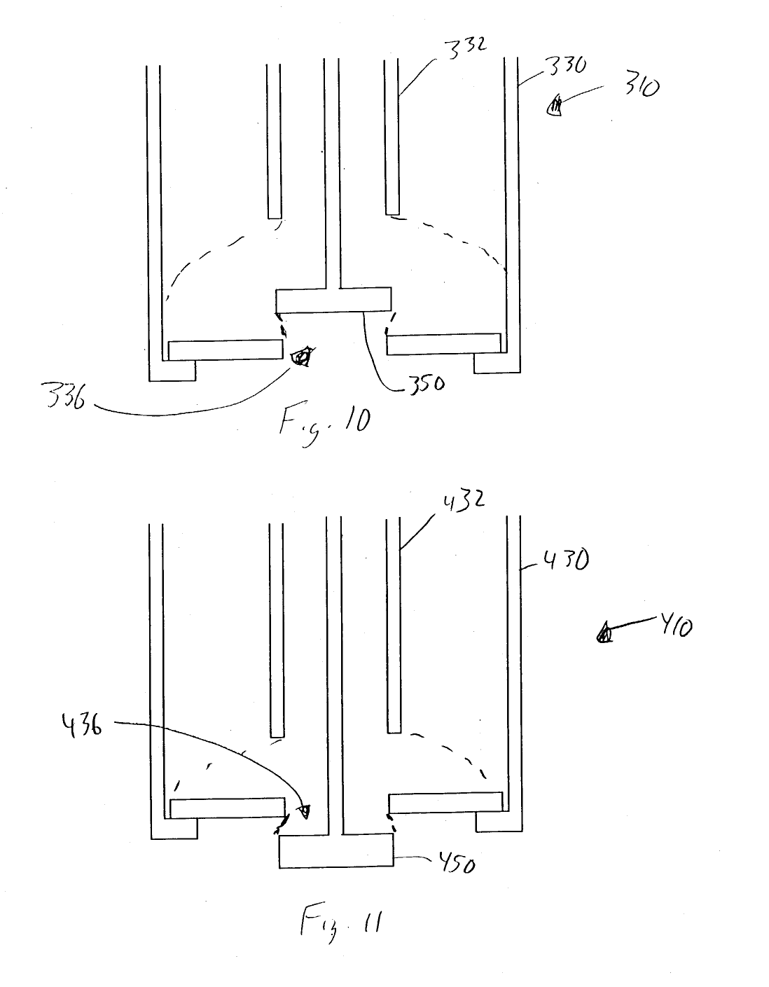

An alternative delivery system 310 is illustrated in FIG. 10. This delivery system 310 includes the tube 330 and funnel 332 described above. Instead of a crucible, an optionally rotating feed disk 350 is provided over the opening 336 that leads to the furnace chamber. In operation, the particles are positioned around the feed disk and have sloping surfaces below the feed disk leading to the opening 336, as indicated by dotted lines in FIG. 10. The particles can be advanced through the opening 336 by magnetic or mechanical tapping of the tube 330, as described above, or by rotating the feed disk 350, or both.

Another delivery system 410 is illustrated in FIG. 11. This delivery system 410 includes the tube 430 and funnel 432 described above. Instead of a crucible, an optionally rotating feed disk 450 is provided beneath the opening 436 that leads to the furnace chamber. In operation, the particles form around the feed disk and have sloping surfaces from the opening 336 over the feed disk, as indicated by dotted lines in FIG. 11. The particles can be advanced into the furnace chamber by magnetic or mechanical tapping of the tube 430, as described above, or by rotating the feed disk 450, or both.

Adjuvants can be added to a coal fly ash feedstock or to a very fine, for example, less than about 0.1 mm in particle size, coal slag feedstock, to change the surface character of the spherulized particles. Such adjuvants are typically added as a fine powder, adhere to the feedstock particle surface or contact the particle surface while molten and, thus, become a part of the surface of the particle. Pigments can be added to change the surface color, such as titanium dioxide added to whiten the surface. Metals such as copper or aluminum can be added to make the particle surface conductive. Other metals such as silver or gold can be added to make the particle surface optically reflective or to enhance the aesthetic characteristics. Flow enhancers, for example, powdered graphite, talc or mica, can also be added to the feedstock.

Additives which can be combined with the ash feedstock or finely divided slag feedstock prior to agglomeration include materials which provide, for example, Al₂O₃ to provide added hardness, B₂O₃ to provide added stiffness, BaO or SrO to improve toughness, Na₂O or K₂O to lower the melting point, although an increase in leachability may also result, and H₂O, NO, NO₂, SO₃, or CO₂, to provide porous or hollow spheroids, or mixtures thereof

The spherulized particles can be coated after cooling with such materials as, for example, pigments to alter color, metals to alter properties such as, for example, conductivity or reflectance, lubricants, and hydrophobic materials. Such coating materials can be coated on the spherulized particles in a fluidized bed with heat, by application including a bonding agent such as, for example, a resin bonding agent, or other coating means well-known to the art.

The spherulized particles of the invention have various chemical compositions depending on the source of the feedstock. For example, slag (e.g., coal slag) and ash (e.g., coal fly ash or incinerator ash) generally have the following composition:

SiO₂, generally in the range of about 20 to 60 weight percent, typically in the range of about 25 to 55 weight percent; Al₂O₃, generally in the range of about 7 to 35 weight percent, typically in the range of about 8 to 25 weight percent; Fe₂O₃ or FeO, or both in combination, generally in the range of about 1 to 35 weight percent, typically in the range of about 5 to 20 weight percent; CaO, generally in the range of about 1 to 45 weight percent, typically in the range of 5 to 40 weight percent; and Na₂O and K₂O, generally in the range of about 0.1 to 4 weight percent.

The spherulized particles of the invention can be used in various processes and products for which the irregularly shaped feedstock would be unsuitable. Such processes include, for example, shot-peening, polishing, sandblasting of soft materials or precision surfaces, and filtering. The spherulized particles can be used, for example, as fluidized heat transfer media, flowable construction fill, aggregate for concrete or mortar, hydraulic fracturing proppant, and plastic or lubricant filler due to the high flowability, smooth surface and compact shape of the spheroidal particles. The spherulized coal slag particles can be crushed under pressures of, for example, at least about 700 MPa (100,000 psi) and used as roofing granules, abrasives, and the like.

One specification for shot peening particles used in metal finishing requires that at least 70 or 80% of the particles have an aspect ratio of 1.2 or less and that there be at most 3% sharp particles (particles with broken or angular surfaces or unfired edges). Generally for hydraulic fracturing, the particles preferably have an aspect ratio of no more than about 1.5, and preferably, no more than about 1.2. Particles for these applications can be made using the methods described herein.

In some instances, the formation of spherulized slag or ash particles is performed to make a product or simply to process waste and increase the bulk density of the material (e.g., to reduce the volume for a given weight of waste) or to reduce leachability of one or more contaminants from the waste or both. If increased density of the slag or ash is desired, the spherulization of the slag or ash particles preferably results in an increase in density of at least 10%, more preferably, at least 50%, and most preferably, at least 100% over the original slag or ash particles that have been dried to remove water.

Generally, the methods described herein produce at least a non-porous surface. This non-porous surface can reduce leachability of the particles. If reduced leachability is desired, the spherulization of the slag or ash particles preferably reduces the leachability of one or more components of the slag or ash particles by at least 10%, more preferably, at least 50%, and most preferably, at least 100% over the original slag or ash particles. Examples of substances in the slag or ash that could benefit from reduced leachability include metals, such as, for example, lead, chromium, cadmium, arsenic, selenium, silver, barium, mercury, and nickel. Preferably, the leachability of one or more of the following is reduced: lead, chromium, and selenium. The spherulization can be used to reduce the leachability of any one or more of these metals. Preferably, the leachability is reduced to below a drinking water standard, such as the standard indicated in the examples below.

Typically, the resulting particles are generally spheroidal. The methods described herein can be used, if desired, to produce particles that have an average aspect ratio (measured as described below in the Examples) of 1.4 or less and, in some embodiments, 1.2 or less, or even 1.1 or less. The median aspect ratio can be, for example, 1.1 or less, 1.05 or less, or even 1.03 or less. In some embodiments, at least 50% of the particles have an aspect ratio of 1.2 or less and, in some instances, at least 90% or 95% of the particles have an aspect ratio of 1.2 or less. These spheroidal particles can be made so that the particles roll freely across a flat-bottom aluminum sample dish tilted at 3° with respect to the horizontal.

The spheroidal particles made by the methods described herein can be transparent or translucent. It was found that for fly ash, internal voids can be formed. It is believed that these internal voids are the result of the production of H₂O or SO₃ gas and can be 1/10 of the diameter of the particle or larger. These particles could be used, for example, in flowable construction fill, pumped concrete, grouting mortar, or as low-density filler for composites. In some embodiments, at least 25%, at least 50%, or at least 90% of the particles have at least one internal void that has a diameter that is at least 1/10th of the diameter of the particle.

The invention is further illustrated by the following examples, but the particular materials and amounts thereof recited in these examples, as well as other conditions and details, should not be construed to unduly limit this invention. All parts and percentages are by weight unless otherwise indicated.

### EXAMPLES

### Example 1

Referring to FIG. 1, a Kimax™ borosilicate glass funnel having about a 51 mm (2 in.) diameter top opening and about a 152 mm (6 in.) long stem with the inner diameter of the stem being about 2.5 mm (0.1 in.) was placed into a feed tube. The feed tube of Kimax™ borosilicate glass had an inner diameter of about 17 mm (0.67 in.) and was about 152 mm (6 in.) long and was supported by wires resting on the top edge of the drop tube. The bottom of the feed tube was slightly convex and had about a 1 mm (0.025 in.) discharge port in the center thereof. The stem of the funnel was flush with the inside wall of the feed tube. The feed tube was suspended in the upper portion of a drop tube which was of fused quartz and had an inside diameter of about 25 mm (1 in.), and outside diameter of about 29 mm (1.14 in.), and a length of about 0.97 m (38.25 in.).

A ferrite ceramic magnet with a diameter of about 12.7 mm and a thickness of about 4.8 mm was suspended by means of a nichrome wire inside the feed tube and about 25 mm (1.0 in.) above the discharge port. The magnet was wrapped in 2 layers of aluminum foil, about 25 μm thick, to prevent contamination of the feedstock with ferrite magnetic particles. Enameled copper wire having a total diameter of about 1.71 mm, the wire being about 1.63 mm in diameter (14 gauge) formed a wound coil. The coil had an inner diameter of about 44 mm, an outer diameter of about 88 mm, and a thickness of about 24 mm, with an inductance of about 2.2 mH and a series resistance of about 0.33 ohms, was connected to a 12 volt pulse generator through a 4 ohm 50 watt current-limiting resistor. The coil was placed surrounding the outer portion of the drop tube with the lower surface of the coil about 19 mm (0.75 in.) above the discharge port and intermittent current was supplied to the coil which caused the magnet to intermittently rap the feed tube to provide continuous discharge of the feedstock through the discharge port.

A 2040 watt heating element which was normally operated at about 900 to 1000 watts and which had an inner diameter of about 32 mm (1.26 in.), an outer diameter of about 52 mm (2.05 in.) and a length of about 0.6 m (24 in.) and was powered directly from an AC line carrying about 200 V rms through a 25 amp solid-state relay, the duty cycle of which was controlled by an adjustable pulse generator, to obtain the required heater temperature. The top of the heating element was located about 23.5 cm (9.25 in.) below the top of the drop tube.

Insulation of vitreous aluminosilicate ceramic fiber, available from Thermcraft, Inc., which had an inner diameter of about 5.2 cm (2.05 in.), an outer diameter of about 19.1 cm (7.5 in.) and a length of about 71 cm (28 in.) was placed around the drop tube and heating element and extended downward from a position about 18.4 cm (7.25 in.) from the top of the drop tube.

An aluminum structural shell having a wall thickness of about 0.32 mm (0.0125 in.) surrounded the insulation and extended about 12.7 cm (5 in.) above the insulation and about 7.6 cm (3 in.) below the insulation. The aluminum shell rested on an about 30.5 cm (12 in.) square aluminum blower box cover which was about 2.9 mm (0.114 in.) thick. The blower box of about 0.79 mm (0.031 in.) thick aluminum was about 30.5 cm (12 in.) square and about 7.6 cm (3 in.) in height. The blower box cover had a circular opening about 5.1 cm (2 in.) in diameter, substantially centered in the top thereof, through which the drop tube extended. A Type FN12B3, 12 volt, 220 mA blower available from Comair-Rotron was placed in the blower box proximate a port 7.9 cm (3.125 in.) square. The blower was rated to provide a static pressure of about 68 Pa (0.27 in H₂O) at zero flow and full power. A motor speed control reduced the motor power to provide a static pressure of about 1.5 Pa (0.006 in H₂O) at zero flow to oppose the chimney effect in the drop tube.

A Kimax™ borosilicate glass funnel having a mouth about 7.6 cm (3 in.) in diameter was located in the blower box such that the mouth of the funnel was about 1.25 cm (0.5 in.) below the blower box cover. The lower end of the drop tube was flush with the lower surface of the blower box cover. The stem of the funnel, about 1.28 cm (0.50 in.) inner diameter, about 1.69 cm (0.67 in.) outer diameter and about 3.5 cm (1.38 in.) long extended through an opening about 1.9 cm (0.75 in.) in diameter in the base of the blower box. A Kimax™ borosilicate glass catch tube having an outer diameter of about 2.5 cm (1 in.) and a length of about 5.0 cm (2 in.) was sealed onto the terminus of the funnel stem to collect the spherulized product.

At the midpoint of the heating element, a horizontal bore having a diameter of about 6.3 mm (0.25 in.) extended through the structural shell, the insulation and the heating element. Into this bore was placed a closed-end mullite/glass tube having an inner diameter of about 4.5 mm (0.18 in.), and outer diameter of about 6.3 mm (0.25 in.), and a length of about 15 cm (6 in.) such that the closed end of the mullite/glass tube abutted the drop tube. A type K thermocouple fabricated from about 0.81 mm diameter (20 gauge) Chrome/Alumel™ wire was seated within the mullite/glass tube to measure the temperature at the midpoint of the heated portion of the drop tube.

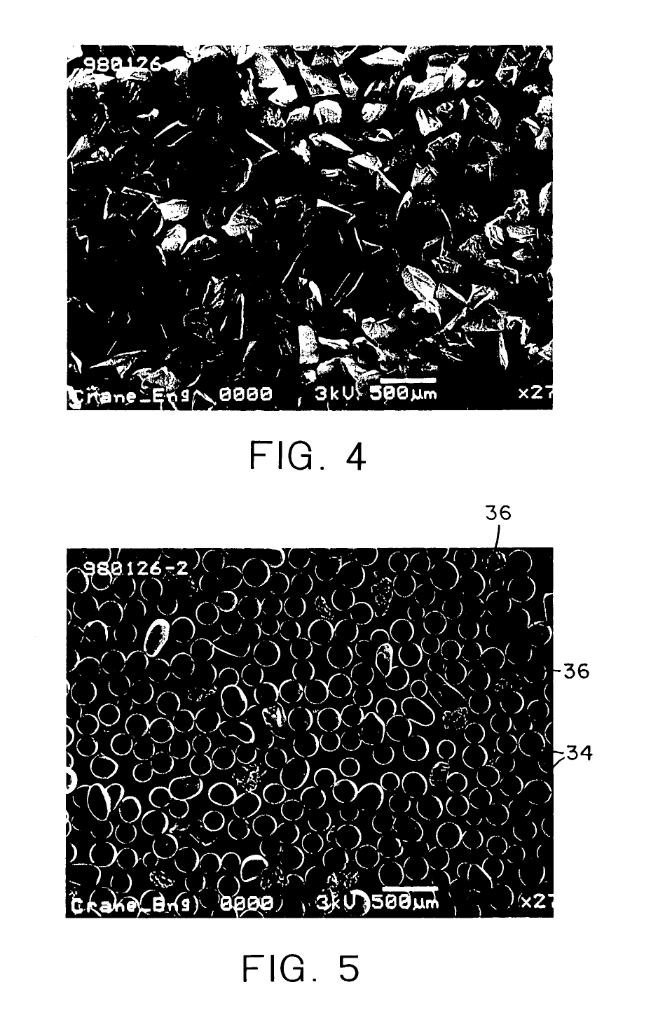

The heating element was turned on and when the temperature of the drop tube, as measured by the thermocouple, reached about 1250° C., coal slag feedstock, such as that shown in FIG. 4, having a particle size of about 0.23 to 0.27 mm fed through the funnel into the feed tube. The terminal portion of the funnel stem was at a height above the bottom of the feed tube such that the feedstock depth in the feed tube was maintained at about 1 mm. The feed tube was rapped an average of about 9 times per second by the magnet at a magnetic torque of roughly 0.001 Nm in 10 msec pulses causing the feedstock to enter the drop tube at a rate of about 2.4 mg/sec. The residence time of the particles in the feed tube was about 0.5 seconds.

The product which was spherulized in the heated portion of the drop tube was sufficiently cool when it was discharged from the drop tube that minimal sticking together of particles occurred. The product yield was about 83% of the mass of the particles fed into the drop tube.

Five spheroids were randomly chosen and tested for hardness using a Vickers Diamond pyramid penetrator with a 50 g load. The hardness ranged from 478 HV to 551 HV, with an average of 503 HV, The bulk density of the spheroidal slag product was determined to be roughly 1.8 g/cm³.

Up to about 30% of the product was in the form of duplex particles, at least about 70% of which readily disassociated in the course of normal handling. On inspection, about 90% of the irregularly shaped feedstock particles were spherulized. The spherulized coal slag product can be seen in FIG. 5. In FIG. 5 spherulized product 34 can be seen to be generally spheroidal, ranging from somewhat elongate to substantially spherical. Irregular particles 36 are suspected to be unburned coal or contaminant due to use of material other than coal in the combustion mix for the coal-fired boiler.

### Example 2

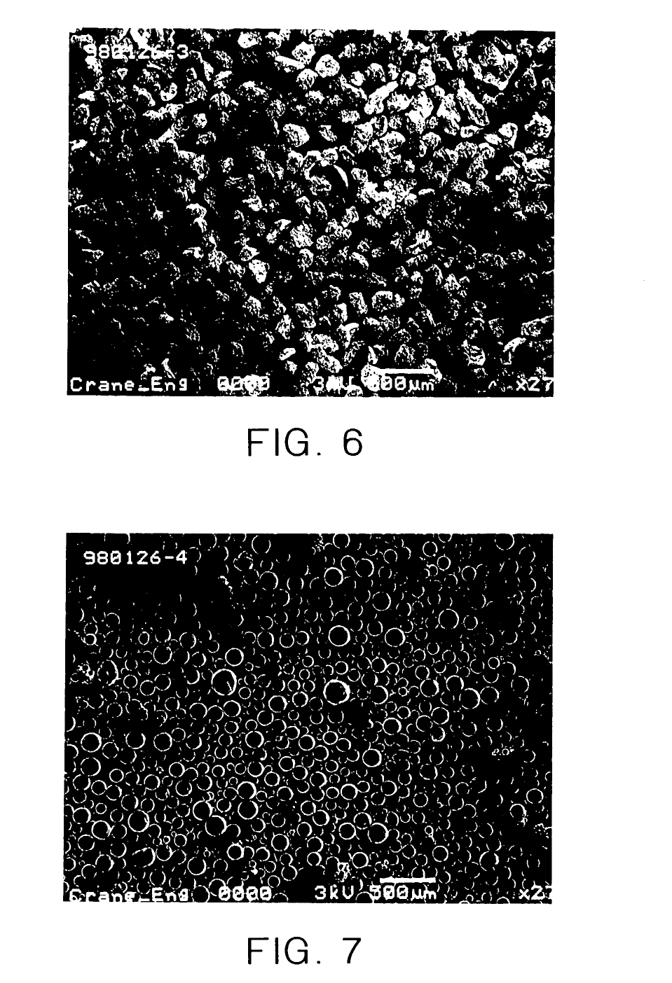

The same apparatus was used as described in Example 1. Coal fly ash was obtained from an electric power generating plant burning low-sulfur subbituminous coal known to form an ash having a high enough CaO content to self-cement. The fraction of as-received agglomerated granular feedstock that was about 0.16 to 0.23 mm in size, shown in FIG. 6, was oven dried for about 3.5 hours at about 265° C. The bulk density of this coal fly ash feedstock was determined to be roughly 0.6 g/cm³. When the drop tube temperature reached about 1250° C. as determined by the thermocouple reading, the oven-dried agglomerated coal fly ash was fed through the funnel into the feed tube. The feed tube was rapped at an average rate of about 9 times per second by the magnet as in Example 1, causing the feedstock to enter the drop tube at a rate of about 0.35 mg/sec. Due to the smaller size and lower bulk density of the feedstock, the bulk density being about 35% that of coal slag feedstock, the feed rate was significantly less than in Example 1.

The product which was spherulized in the heated portion of the drop tube was sufficiently cool when it was discharged from the drop tube that no sticking together of particles occurred. On inspection, substantially all of the irregularly shaped coal slag feedstock particles were spherulized. The product yield was about 75% of the mass of the particles fed into the drop tube.

Spheroids were randomly chosen and tested for hardness using a Vickers Diamond pyramid penetrator with a 50 g load. The hardness could not be determined due to the friability of the spheroidal particles. The bulk density of the spheroidal fly ash product was determined to be roughly 1.8 g/cm³.

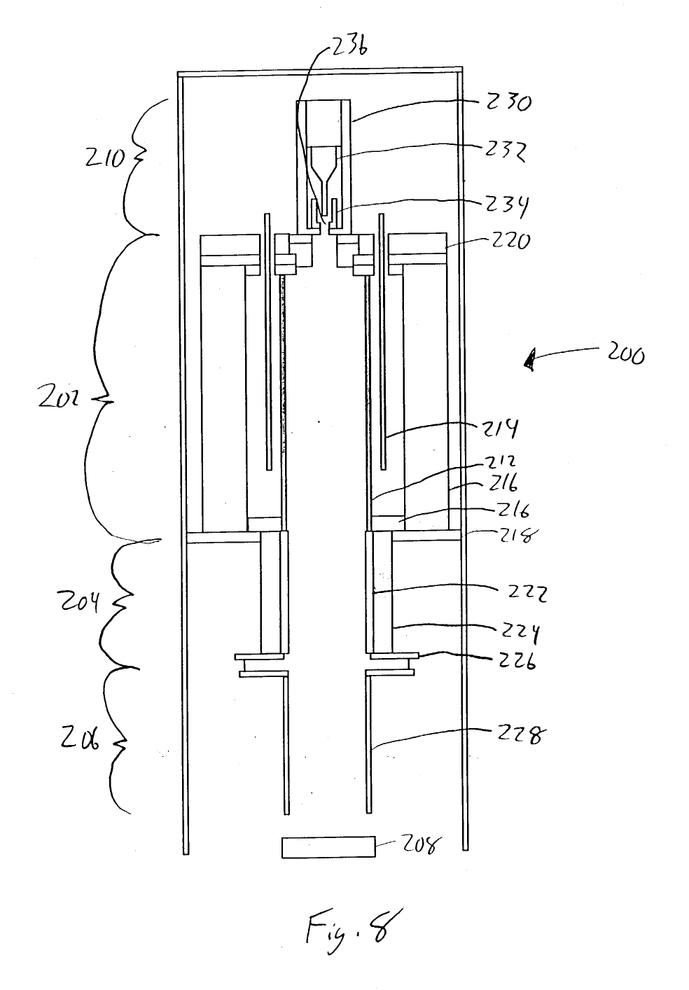

The spherulized coal slag product can be seen in FIG. 7. In FIG. 7, the product can be seen to be substantially spheroidal.

### Example 3

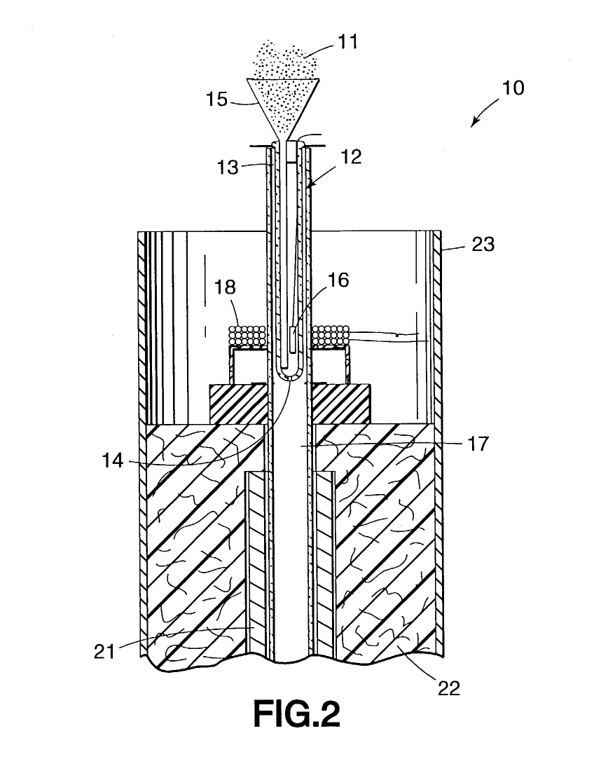

An apparatus was set up as in FIG. 2, with the omission of heating element 21, insulation 22, and shell 23. A tube having an inner diameter of about 7.6 cm (3 in.) and a length of about 61 cm (24 in.) was substituted for the quartz drop tube. A clamp supported the feed tube, located at its upper end. Coal slag feedstock, about 0.32 mm to 0.4 mm in size, was fed into the funnel and was allowed to fall to the lower portion of the drop tube. The coil was powered such that the magnet rapped the inner wall of the feed tube once per second at a magnetic torque of roughly 0.001 Nm and a pulse width of about 10 msec.

A sheet of paper 21.6 cm wide and 27.9 cm long, marked with concentric circles from 1 cm to 10 cm diameter in 1 cm increments, was sprayed for about one second with Super 77™ Spray Adhesive, available from 3M Company, at a distance of about 30 cm with the spray directed to the center of the circular pattern. The paper was centered about 6 mm (0.25 in.) beneath the drop tube. Within no more than 60 seconds after spraying the adhesive, power was supplied to the coil as described above and the magnet began rapping the feed tube. After 45 seconds, the power was turned off and the paper was removed from beneath the drop tube. Evaluation by visual inspection showed that 86% of the 154 coal slag particles adhering to the paper fell within the 3 cm circle on the paper.

### Example 4

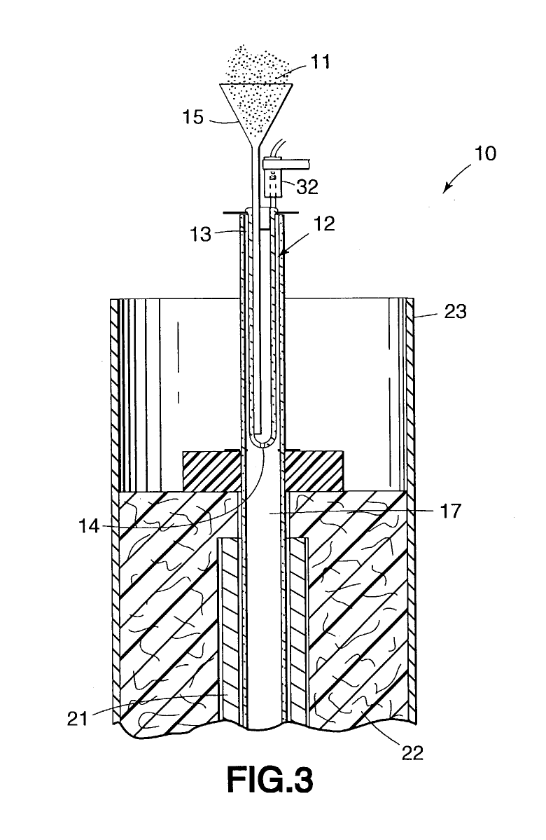

An apparatus was set up as in FIG. 3, with the omission of heating element 21, insulation 22, and shell 23, and the solenoid being oriented at about a 45° downward angle to the rim of the feed tube with the solenoid slug abutting the feed tube rim. The solenoid used was about 1.2×1.2 cm wide×2.5 cm long with a 6 VDC, 38 ohm coil, and a 4.8 mm diameter×27 mm long steel slug. The slug was fitted on its inside end with a 6-turn steel spring having an average coil diameter of 3 mm and a length of about 6 mm, wound from about 0.25 mm diameter high-carbon steel music wire. The solenoid was connected to a 12 V pulse generator and was driven with 10 msec pulses at a rate of about 9 pulses per second.

Coal slag feedstock, about 0.32 mm to 0.4 mm in size, was fed into the funnel and was allowed to fall to the lower portion of the drop tube. Power was supplied to the solenoid as described above to effect rapping of the feed tube. The feed rate of the coal slag feedstock was determined to be about 1 mg/sec.

### Example 5

A second apparatus (e.g., furnace) was prepared. This apparatus is schematically illustrated in FIG. 8. The apparatus includes a cylindrical furnace chamber having a 24 inch outer diameter and a 12 inch inner diameter and a 48 inch length. There were three layers of ceramic fiber insulation provided having a total thickness of 6 inches and an inner diameter of 12 inches. The inner layer of insulation was 1065-18 ceramic fiber from Rex Roto Corp., Fowlerville, Mich., the middle layer of insulation was Durablanket™ 2600 from Unifrax Corp., Niagara Falls, N.Y., and the outer layer of insulation was 1020-12 ceramic fiber from Rex Roto Corp., Fowlerville, Mich. At the top of the furnace chamber was a 14 inch outer diameter circular disk (3464-25 ceramic fiber, Rex Roto Corp.) stacked beneath two 24 inch outer diameter circular disks (1065-18 and 1020-12 ceramic fiber, Rex Roto Corp., respectively). These circular disks had slots cut into them for the heating elements and a center hole for the passage of the feedstock. The furnace chamber was supported on a base plate (28 inch square, 0.5 inch thick, type 304 stainless steel, 12.5 inch center hole). The furnace chamber was leveled plumb with±⅛ inch deviation from top to bottom using leveler bolts located at comers of the base plate.

A drop tube (5.25 inch inner diameter, 6 inch outer diameter, and 47 inch length) was centered coaxially within the furnace chamber. The interior of the drop tube was cast from nitride-bonded silicon carbide (mix #88-79, New Castle Refractories, New Castle, Pa.).

Four U-shaped heating elements were used. The heating elements were made of molybdenum disilicide (type MD-33, size 6/12, I Squared R Element Co., Akron, N.Y.). Two of the elements were 40 inches long and the other two were 20 inches long. Each element was a 0.25 inch diameter rod with a hairpin loop to make the rod U-shaped with two 0.5 inch terminal rods welded at the upper ends. The four elements were positioned at corners of a square centered on the axis of the furnace chamber and spaced four inches away from the center axis (i.e., 1 inch beyond the outside of the drop tube.) The elements were driven using a 480 volt phase-angle SCR power controller with a 480V/48V, 200 amp delta/wye stepdown transformer and a Eurotherm™ 2416 temperature controller, all available from Merrimac Industrial Sales, Inc., (Boston, Mass.). The temperature was monitored using a 24 gauge type B thermocouple in a ¼ inch outer diameter alumina protection tube from Omega Engineering, Inc. (Model, BAT-24-18, Stamford, Conn.). The thermocouple was located 3.5 inches below the top of the furnace chamber and at 5.5 inches from the center axis of the furnace chamber.

The drop tube rested on an outlet duct (6 inch inner diameter, 8 inch outer diameter, and 24 inch length) made of Unicor 50 ceramic (alumina-zirconia-silica) from Corhart Refractories, Louisville, Ky. Between the outlet duct and the drop tube was a an intermediate ring of Unicor 501 ceramic (5 inch inner diameter, 7 inch outer diameter, and 2 inch length). This ring is provided to possibly redirect molten material flowing down from the walls of the drop tube, away from the wall of the outlet duct and instead allowing the material to drip through the outlet duct. The outlet duct was supported on a 20 inch square plate of 0.5 inch thick type 330 nickel alloy having a 7 inch diameter center hole. Between the outlet duct and the support plate was a 0.5 inch thick ring of ceramic fiber insulation (AC-3000, Smart Ceramics, Woburn, Mass). The outlet duct was surrounded by a 2 inch thick cylindrical shell of ceramic fiber insulation (1065-18 ceramic fiber, Rex Roto, Corp.).

A cooling zone was provided beneath the outlet duct. The cooling zone included a type 304 stainless steel duct (12 inch outer diameter, 20 gauge, 60 inch length) in Examples 6-8 or a flexible aluminum duct (8 inch outer diameter, 60 inch length) in Example 5. A 15.5 inch diameter, 12 quart stainless steel bowl was provided as a catch basis below the cooling zone.

The apparatus was operated at a temperature of 1400° C.±3° C. as measured by the thermocouple. The typical power needed to maintain this temperature was 7 kW±10%, with 95 amps through each 40 inch heating element and 90 amps through the two 20 inch heating elements connected in series.

The apparatus was mounted on a platform that was 42 inches square and 20 feet tall with the furnace base plate positioned 106 inches above the floor. The platform was fabricated from A36 carbon steel.

The delivery system was similar to the delivery system schematically illustrated in FIG. 9. The delivery system included a cylindrical crucible (50 mL, 1.25 inch inner diameter, 2.5 inch height, 99.8% alumina, part # 65537, CoorsTek, Golden, Colo.). A stainless steel funnel emptied into the crucible through a vitreous quartz tube (1.16 inch outer diameter, 1.0 inch inner diameter, 22.5 inch length). A center hole was drilled in the crucible. In Example 5, the center hole had a 2 mm diameter and in Examples 6-8, the center hole had a 3 mm diameter. The crucible rested on a support disk (1 inch inner diameter, 2.45 inch outer diameter, 0.125 inch thickness, silicon carbide, type Hexoloy SA from Carborundum Co., Niagara Falls, N.Y.). The bottom end of the crucible was cemented to a ceramic fiber disk (AC-3000, Smart Ceramics, Woburn, Mass.) with a conical hole (0.5 inch outer diameter at the bottom and 0.3 inch outer diameter at the top) that was aligned with the hole in the crucible. The crucible and support disk rested in a Kimax™ borosilicate quartz tube (Glass Instruments, Inc., Pasadena, Calif.) having a 2.76 inch outer diameter, 2.58 inch inner diameter, and 18 inch length. The tube was supported by a 5.5 inch×6 inch rectangle cut from 0.005 inch thick type 304 stainless steel. The rectangle included a 2.8 inch center hole for passage of the tube and rested on a 10 inch outer diameter, 0.25 inch thick aluminum plate having a 5 inch center hole.

The bottom end of the tube rested against a ceramic fiber gasket (4.88 inch outer diameter, ASPA-1 ceramic fiber, Zircar Products, Inc., Florida, N.Y.). This gasket provided a seal to reduce any furnace chamber chimney effect and to prevent a draft that could scatter the feedstock against the walls of the apparatus. The ceramic fiber gasket rested on a 2 inch thick insulating disk (1065-18 ceramic fiber, Rex Roto Corp.) having a 1.25 inch diameter center hole and an outer diameter of 4.88 inches for the top 1 inch of the disk and 3.88 inches for the bottom 1 inch of the disk. This disk covers the 4 inch center hole in the disks at the top of the furnace chamber to reduce heat loss and reduce heating of the other components of the delivery system.

The flow of material was maintained by tapping on the top rim of the Kimax™ borosilicate quartz tube using two solenoids (Guardian LT12×19-I-12D, Newark Electronics, Chicago, Ill., catalog #62F3682, 1.5 inch outer diameter, 2.375 inch length, 12 volt, 2.5 amp, 15 oz. pull at 0.75 inch extension). The ends of the metal slugs in the solenoids were cushioned using female copper pipe caps. The metal slugs extended 0.57±0.05 inches from their seated positions. The solenoids were positioned on opposite sides of the tube and were driven in parallel. The solenoids were powered using a custom-built 5 amp pulse generator with an output voltage of 10±1 volts that produces 7 millisecond rectangular pulses with a 1 second period.

Boiler slag (40/80 product from Black Diamond, Woodbury, Minn.) was obtained. This boiler slag contains particles where 95 wt. % of the particles pass a 40 mesh sieve and are retained on a 100 mesh sieve. Trace amounts of oversized granules were removed using a 30 mesh sieve.

At an average rate of 10.5 g/min, 997 g of the sieved material was dropped through the furnace. In the catch bowl under the furnace, 991 g of material (99.4% yield) was recovered.

A 10.8 g sample of product from the furnace was dried for 1 min. in a microwave oven on HIGH. The sample weight did not substantially decrease (within a resolution of 0.1 g). The sample was loaded on top of a stack of 8″ diameter 40, 70, and 100 mesh U.S. standard sieves. The stack was clamped into a mechanical sieve shaker and shaken for 1 min. at about 7 Hz with 0.75 cm peak-to-peak amplitude. After collecting the sieve fractions, the 9.4 g of material retained on the 70 mesh sieve was loaded on the sieve stack again and shaken for 1 min. The weight of the fraction retained on the 70 mesh sieve decreased to 9.0 g. The sieve fractions from this second separation were combined with the corresponding fractions from the first separation. The combined weights were:

| | |
|---|---|
| 40 mesh sieve | 0.2 g |
| 70 mesh sieve | 9.0 g referred to as “40/70” |
| 100 mesh sieve | 0.9 g referred to as “70/100” |
| pan | 0.0 g |
| loss | 0.7 g |

The 40/70 and 70/100 mesh fractions of the fused product were sprinkled on double-sided adhesive carbon tape mounted on a 2 inch diameter aluminum stub. Each of the samples covered an area of approximately 1.0 cm to 2.0 cm long×0.7 cm wide on the tape.

The samples were photographed using a JEOL JSM-5800LV scanning electron microscope, at a working distance of 20 mm, using backscatter electron imaging at a vacuum of approximately 0.3 torr. The magnification was 25×, 50×, and 100×. The aspect ratio of individual particles was measured as observed on the SEM photographs. Particles were randomly selected in all photos. No particle was measured twice. Only particles with their entire perimeter visible were measured. The apparent maximum and minimum diameter of the particle was measured and recorded, using a Fowler 52-008-005 dial caliper calibrated in 0.025 mm (0.001 inch) increments, with a repeatability of about +/−0.25 mm (0.01 inch). On highly spherical particles, if the major and minor axes were not obvious, then 3 to 5 readings were taken and the minimum and maximum of these values were recorded. The aspect ratio of the particle was calculated as the ratio of its maximum diameter to its minimum diameter, as specified in SAE AMS 2431/6 (4-1-1988), table 1, note 2. The 70/100 sample was measured twice, in photos at both 50× and 100×, to determine the effect of image diameter on the measurement. The 100× photos were zoom images of those at 50×, and some of the particles measured at 100× were duplicates of those measured at 50×.

TABLE 1
Particle Aspect Ratio (AR)

| sample | 40/70 | 70/100 | 70/100 |
|---|---|---|---|
| magnification | 25 | 50 | 100 |
| average AR | 1.261 | 1.058 | 1.046 |
| median AR | 1.082 | 1.040 | 1.022 |
| % < 1.2 AR | 60 | 95 | 95 |
| N | 20 | 20 | 20 |
| average d, inch | 0.327 | 0.354 | 0.718 |

“% < 1.2 AR” means the percentage of the number of particles measured with aspect ratio less than 1.2.
“average d, inch” is the average of the average minimum and average maximum apparent diameter of all of the particle images measured in the photos.

An 0.7 g sample of fused product was sieved manually for 15 seconds on a stack of 40 mesh and 70 mesh U.S. standard sieves. 0.7 g of material that passed the 40 mesh sieve was retained on the 70 mesh sieve. A sample of this 40/70 material was embedded in plastic, then ground and polished flat to expose the interior of the particles. Indentations were made on 10 separate particles to determine Vickers hardness, using a Shimadzu Seisakusho Micro-Hardness Tester, Type M, with a 100 g indenter load. The average hardness reading for 10 particles was 644.3 HV with a standard deviation of 10.7 HV.

A sample of the 0.9 g of fused product sieved to 70/100 mesh size for the aspect ratio measurement above, was mounted and tested for hardness in the same way as above. The average hardness reading was 636.8 HV with a standard deviation of 21.2 HV.

### Example 6

The same raw material, a coal fly ash, as described in Example 2 was used. The same conditions as in Example 5 were used, except that a crucible with a 3 mm feed hole was installed. 198 g of 40/70 mesh ash pellets was sieved from 3200 g of ash and dried at 250° C. for 2.25 hours. The sample weight declined 10.6% the first 1.25 hours and 1.1% in the remaining hour of drying. A total of 154.8 g was loaded in the feeder hopper in 3 batches and fed into the furnace at an average rate of 10.3 g/minute (1.36 lb/hr). 125.5 g (81.1%) of fused product was recovered in the catch bowl under the furnace.

A sample of the sieved and dried coal fly ash, and a sample of the fused product were sprinkled on double-sided adhesive carbon tape mounted on a 3 inch diameter aluminum stub. Each of the samples covered an area approximately 2.0 cm long×0.7 cm wide on the tape. The samples were photographed using an SEM as in Example 5. The magnification was 25× (i.e., 25 times), 100×, 400×, and 1000×.

The loose bulk density of the sieved and dried feedstock and the fused product was measured using two methods.

Method 1. A weighed sample of sieved and dried ash was placed in a 16 oz. cylindrical plastic jar with an average inside diameter of 3.16″. The sample was shaken gently a few times to level the surface of the material to within +/−0.05″. The depth of the sample was measured at, at least 3 locations around the perimeter of the jar, and an average was recorded. The sample volume calculated using the formula V=3.14*h*d²/4, where h=sample depth and d=average inside diameter of the jar. The bulk density of the sample was calculated by dividing the weight of the sample by its volume.

The loose bulk density of the fused ash product was measured in the same way, except that the average inside diameter of the jar was 3.14″ (the jar was tapered slightly, narrower on the bottom, and the sample depth was less).

Method 2. ASTM method D-1475 was modified for use with dry samples.

TABLE 2
Loose Bulk Density

| | 40/70, dried | 40/70, fused |
|---|---|---|
| method 1, g/cc | 0.66 | 1.36 |
| method 2, lb/cu.ft. | not tested | 81 |

Samples of the original coal fly ash and the fused product were prepared according to EPA method 1311 and 3010A, Toxicity Characteristic Leaching Procedure for Metals, by Corrosion Control Consultants and Labs, Inc., Kentwood, Mich. Leachate was analyzed using ICP (inductive coupled plasma) spectroscopy. Leachability was measured according to EPA 6010B (ICP-AES Method for Determination of Metals). Mercury was measured according to EPA 7470A (Mercury in Liquid Waste—Manual Cold-Vapor Technique).

TABLE 3
Leachability, ppm

| | Coal Ash | | | | Drinking |
|---|---|---|---|---|---|
| | as- | Reporting | Coal Ash, | Reporting | Water |
| | received | Limit | 40/70, fused | Limit | Standard |
| lead | ND | 0.013 | ND | 0.10 | 0.05 |
| chromium | 0.12 | 0.050 | ND | 0.050 | 0.05 |
| cadmium | ND | 0.013 | ND | 0.013 | 0.01 |
| arsenic | ND | 0.013 | ND | 0.013 | 0.05 |
| selenium | 0.08 | 0.013 | ND | 0.013 | 0.01 |
| silver | ND | 0.005 | ND | 0.005 | 0.05 |
| barium | 0.18 | 0.005 | 1.8 | 0.005 | 1.0 |
| mercury | ND | 0.0005 | ND | 0.0005 | 0.002 |
| nickel | 1.3 | 0.01 | 1.3 | 0.01 | (none) |

Notes:
“ND” = not detected (i.e., below reporting limit)
EPA Primary drinking water standards (mg/L = ppm) are from Table 3 in D.J.

Hassett, Scientifically valid leaching of coal conversion solid residues to predict environmental impact, Fuel Processing Technology 39 (1994) 445-459.

### Example 7

Electrostatic precipitator fly ash from coal fired cyclone boilers was obtained. The same conditions as in Example 6 were used. 1705 g of minus 8 mesh pellets were sieved from 2534 g of the original ash. 1512 g of minus 8 mesh pellets was crushed in a hand-operated Straub F-4 cast iron grinding mill using iron alloy grinding discs. 413 g of +40 mesh output from first grind was run through a second time. A total of 381 g of 40/70 mesh ash pellets was sieved from the milled product and dried at 250° C. for 4.25 hours. The sample weight declined 15.0% the first 3 hours of drying. This sample was then stored for 30 months and increased in weight 3.1% during that time. The sample was dried again for 1.25 hour prior to testing in the furnace, and its weight decreased 4.5%.

A total of 141.6 g was loaded in the delivery system in 2 batches and fed into the furnace at an average rate of 22.9 gm/minute (3.0 lb/hr). 124.1 g (87.6%) of fused product was recovered in the catch bowl under the furnace.

Loose bulk density was measured as in Example 6.

TABLE 4
Loose Bulk Density

| | Coal Ash | Coal Ash, 40/70, | Coal Ash, 40/70, |
|---|---|---|---|
| | as-received | milled and dried | fused |
| method 1, g/cc | not tested | 0.98 | 1.05 |
| method 2, lb/cu.ft. | 67.2 | 58.5 | 63.2 |

Leachability was measured as in Example 6.

TABLE 5
Leachability, ppm

| | Coal/Ash | Coal/Ash, | Coal/Ash, | | Drinking |
|---|---|---|---|---|---|
| | as- | 40/70, milled | 40/70, | Reporting | Water |
| | received | and dried | fused | Limit | Standard |
| lead | ND | ND | ND | 0.10 | 0.05 |
| chromium | 0.098 | 0.11 | ND | 0.050 | 0.05 |
| cadmium | ND | ND | ND | 0.013 | 0.01 |
| arsenic | ND | ND | 0.065 | 0.013 | 0.05 |
| selenium | 0.096 | 0.13 | ND | 0.013 | 0.01 |
| silver | ND | ND | ND | 0.005 | 0.05 |
| barium | 0.17 | 0.12 | 0.80 | 0.005 | 1.0 |
| mercury | ND | ND | ND | 0.0005 | 0.002 |
| nickel | 1.0 | 0.012 | 0.18 | 0.010 | (none) |

### Example 8

A composite ash sample from a municipal waste-fired facility was obtained. The ash included about 30% fly ash and about 70% bottom ash. The same conditions as in Example 6 were used. 372 g of 40/70 mesh ash pellets was sieved from 2263 g of as-received ash and dried in two batches at 250° C. for 2 to 3.5 hours. The sample weight declined 18.7% to 19.0% the first 1 hours and 0.0% to 0.8% in the remaining 1 to 2.5 hours of drying.

A total of 144.9 g was loaded in the delivery system in 4 batches and fed into the furnace at an average rate of 4.4 gm/minute (0.58 lb/hr). 122.3 g (84.4%) of fused product was recovered in the catch bowl under the furnace.

Loose bulk density was measured as in Example 6.

TABLE 6
Loose Bulk Density

| | Ash, 40/70, dried | Ash, 40/70, fused |
|---|---|---|
| method 1, g/cc | 0.52 | 1.14 |
| method 2, lb/cu.ft. | 33.4 | 69.6 |

Leachability was measured as in Example 6.

TABLE 7
Leachability, ppm

| | Ash | Re- | Ash, | Ash, | | Drinking |
|---|---|---|---|---|---|---|
| | as- | porting | 40/70, | 40/70, | Reporting | Water |
| | received | Limit | dried | fused | Limit | Standard |
| lead | 0.019 | 0.013 | ND | ND | 0.10 | 0.05 |
| chromium | 0.085 | 0.050 | 0.23 | 1.1 | 0.050 | 0.05 |
| cadmium | ND | 0.013 | ND | ND | 0.013 | 0.01 |
| arsenic | ND | 0.013 | ND | 0.030 | 0.013 | 0.05 |
| selenium | ND | 0.013 | 0.014 | ND | 0.013 | 0.01 |
| silver | ND | 0.005 | ND | ND | 0.005 | 0.05 |
| barium | 0.34 | 0.005 | 0.24 | 0.62 | 0.005 | 1.0 |
| mercury | ND | 0.0005 | ND | ND | 0.0005 | 0.002 |
| nickel | ND | 0.01 | ND | ND | 0.010 | (none) |

### Comparative Example 1

Mineral wool waste shot, marketed as “slag wool aggregate,” was obtained from Sloss Industries Corp. (Birmingham, Ala.). The sample was pre-screened by the manufacturer to pass a 10 mesh sieve.

A 10.8 g sample of the mineral wool shot was dried to 2 minutes in a microwave oven on HIGH. The sample weight decreased 0.2 g in the first minute and 0.0 g in the second minute. The 10.6 g dried sample was sieved using a mechanical shaker in the same way as in Example 5. 3.3 g was retained on the 70 mesh sieve after the first minute of shaking. This was sieved again for 1 minute as in Example 5. 2.8 g was retained on the 70 mesh sieve after the second minute.

The weights of the combined fractions from the first and second minutes were: Retained on, g:

| | |
|---|---|
| 40 = 6.4 g | |
| 70 = 2.8 g | referred to as “40/70” |
| 100 = 0.3 g | referred to as “70/100” |
| pan = 0.5 g | |
| loss = 0.6 g | |

The 40/70 and 70/100 mesh fractions were mounted and photographed as in Example 5. The aspect ratios of individual particles was measured as in Example 5.

TABLE 8
Particle Aspect Ratio (AR)

| sample | 40/70 | 70/100 |
|---|---|---|
| magnification | 25 | 50 |
| average AR | 1.619 | 1.675 |
| median AR | 1.110 | 1.532 |
| % < 1.2 AR | 55 | 15 |
| N | 20 | 20 |
| average d, inch | 0.362 | 0.456 |

An 0.6 g sample of this mineral wool shot was dried for 1 minute in a microwave oven on HIGH. The sample weight after drying was 0.6 gm. The dried sample was sieved manually for 15 seconds on a stack of 40 mesh and 70 mesh U.S. standard sieves. 0.5 g of material passed the 40 mesh sieve and was retained on the 70 mesh sieve. A sample of this 40/70 material was mounted and tested for hardness as in Example 5 above. The average hardness reading for 10 particles was 678.6 HV with a standard deviation of 86.4 HV. A sample of the 0.3 g of mineral wool shot sieved to 70/100 mesh size for the aspect ratio measurement above, was mounted and tested for hardness in the same way as above. The average hardness reading for 10 particles was 682.6 with a standard deviation of 16.0 HV.

### Comparative Example 2

Soda-lime glass beads (MIL-G-9954A size 5, sieve size 40/50 mesh) were obtained from Spesco, Inc., St. Paul. These beads were marketed for shot peening and bead blasting.

A sample of the glass beads was sprinkled on double-sided adhesive carbon tape mounted on a 3″ diameter aluminum stub. The sample covered an area approximately 1.0 cm to 2.0 cm long×0.7 cm wide on the tape.

The glass sample (40/50 mesh as-received) was photographed as in Example 5. The aspect ratio of individual particles was measured as in Example 5.

TABLE 9
Particle Aspect Ratio (AR)

| sample | 40/50 |
|---|---|
| magnification | 50 |
| average AR | 1.067 |
| median AR | 1.040 |
| % < 1.2 AR | 95 |
| N | 20 |
| average d, inch | 0.651 |

A sample of glass as-received was mounted and tested for hardness as in Example 5 above. The average hardness reading was 577.1 HV with a standard deviation of 23.8 HV.

### Example 9

Compositions of Examples 1-8 and Comparative Example 1 and other Parameters

The compositions of Examples 1-8 and Comparative Example 1 were measured according to the ASTM standards listed in Table 10. The results of the test are listed in Table 10.

TABLE 10
Compositions in wt. %

| | ASTM No. | Ex. 1, 3, 4 | Ex. 2, 6 | Ex. 5 | Ex. 7 | Ex. 8 | Comp. Ex. 1 |
|---|---|---|---|---|---|---|---|
| Loss on | D3174 | 1.26 | 12.17 | 0.22 | 13.48 | 18.28 | 1.73 |
| Ignition | | | | | | | |
| Carbon | D5373 | 1.12 | 8.20 | 0.21 | 6.79 | 2.52 | 1.72 |
| SiO₂ | D3682 | 45.72 | 30.53 | 50.46 | 28.70 | 28.60 | 37.60 |
| Al₂O₃ | D3682 | 20.19 | 18.37 | 18.16 | 16.28 | 16.22 | 9.52 |
| TiO₂ | D3682 | 1.12 | 1.26 | 0.97 | 1.20 | 2.31 | 1.00 |
| Fe₂O₃ | D3682 | 5.76 | 5.69 | 15.20 | 6.40 | 2.40 | 5.36 |
| CaO | D3682 | 19.50 | 24.14 | 8.60 | 28.80 | 38.80 | 33.50 |
| MgO | D3682 | 3.72 | 5.92 | 1.65 | 5.80 | 3.52 | 10.10 |
| K₂O | D3682 | 0.48 | 0.84 | 1.60 | 0.68 | 1.88 | 0.86 |
| Na₂O | D3682 | 1.13 | 2.73 | 1.00 | 2.63 | 3.20 | 0.42 |
| SO₃ | D5016 | 0.12 | 6.30 | 0.12 | 3.66 | 1.12 | 0.01 |
| P₂O₅ | D2795 | 0.74 | 2.00 | 0.33 | 3.20 | 0.90 | 0.20 |
| SrO | D3682-ICP | 0.34 | 0.43 | 0.16 | 0.60 | 0.06 | 0.05 |
| BaO | D3682-ICP | 0.52 | 0.7 | 0.29 | 0.85 | 0.12 | 0.07 |
| Mn₃O₄ | D3682 | 0.08 | 0.06 | 0.08 | 0.06 | 0.19 | 0.46 |
| Undetermined | | 0.58 | 1.03 | 1.38 | 1.14 | 0.68 | 0.85 |
| base/acid | | 0.46 | 0.78 | 0.40 | 0.96 | 1.06 | 1.04 |
| ratio | | | | | | | |
| T₂₅₀, ° C. | | 1286 | 1153 | 1323 | 1215 | 1290 | 1266 |

The value of T₂₅₀ represents the temperature at which the sample viscosity is 250 poise.

Tests were performed on the particles of Examples 1 and 2. Particle roundness was estimated from 5 mm to 50 mm diameter images on SEM photos, using a Fowler 50-008-005 dial caliper calibrated in 0.025 mm increments, with a repeatability of about ±0.25 mm. The maximum and minimum apparent diameter was measured and the ratio reported.

Crush strength was measured by squeezing single spheroidal particles between optically flat sapphire discs 10 mm diameter×1 mm thick, obtained from Edmund Scientific Corp., Barrington, N.J., stock #H43366. Force was applied between the anvils of a General #102 outside micrometer, 40 turns per inch, with a torque bar clamped to the handle, or directly to the top sapphire disc using the flat head adapter of an Extech FG-5000 digital force gauge. At the start of each test, the particle diameter was measured using a Starrett #216 outside micrometer, with 2.5 um (0.0001″) vernier resolution. Due to the sphericity of the particles, only one diameter reading was made on each specimen. The force was increased in 5% to 20% increments until the particle crushed with audible “pop”, and the value was read using the peak hold function on the force gauge. The crush strength was calculated by dividing the measured force by the particle cross-sectional area A=πd²/4, where d=particle diameter. The fly ash beads tended to crush when measuring their diameter, so an estimated diameter of 0.20 mm was used, obtained from the SEM photos.

TABLE 11
Mechanical properties of fused particles of Examples 1 and 2

| | 60/70 mesh boiler slag | 70/100 mesh fly ash |
|---|---|---|
| aspect ratio, | median 1.04 | median 1.02 |
| dₘₐₓ/dₘᵢₙ | 80% < 1.06 | 80% < 1.03 |
| | n = 10 | n = 10 |
| crush tests: | | |
| particle diameter, mm | 0.239 to 0.264 | 0.20 (estimated) |
| crush force, N(lb) | 1.5 to 197 | 0.46 to 12 |
| | (0.35 to 44) | (0.10 to 2.7) |
| crush strength, GPa | avg. 1.75 (250) | avg. 0.19 (27) |
| (kpsi) | s.d. 1.52 (220) | s.d. 0.12 (17) |
| number of samples | n = 10 | n = 10 |
| Vickers hardness, GPa | avg. 4.9 (503) | |
| (kg/mm²) | s.d. 0.26 (27) | |
| | n = 5 | |

Various modifications and alterations of this invention will become apparent to those skilled in the art without departing from the scope and spirit of this invention, and it should be understood that this invention is not to be unduly limited to the illustrative embodiments set forth herein.

What is claimed is:

1. A composition comprising particles prepared from slag or ash, the particles having at least a hard outer shell and comprising SiO₂, Al₂O₃, and CaO, wherein the particles have an average aspect ratio of no more than 1.4.

2. The composition of claim 1, wherein the particles have an average aspect ratio of no more than 1.2.

3. The composition of claim 1, wherein at least 50% of the particles have an aspect ratio of no more than 1.2.

4. The composition of claim 1, wherein at least 90% of the particles have an aspect ratio of no more than 1.2.

5. The composition of claim 1, wherein at least 50% of the particles have internal voids.

6. The composition of claim 1, wherein the particles contain chromium and leachability of chromium from the particles is no more than 0.05 ppm.

7. The composition of claim 1, wherein the particles are substantially transparent.

8. The composition of claim 1, wherein at least 25% of the particles have at least one internal void with a diameter of at least 1/10 of the diameter of the particle.

9. The composition of claim 1, wherein at least 90% of the particles have at least one internal void with a diameter of at least 1/10 of the diameter of the particle.

10. A method of processing particles comprising boiler slag or ash, the method comprising steps of:
a) delivering the particles to an inlet of a drop tube furnace;
b) dropping the particles through the drop tube furnace;
c) heating the particles as the particles traverse through a heating portion of the drop tube furnace to melt at least an outer surface of the particles such that a majority of the particles become substantially spheroidal; and
d) cooling the particles as the particles traverse through a cooling portion of the drop tube furnace to deter agglomeration.

11. The method of claim 10, wherein the step of cooling comprises cooling the particles as the particles traverse through a cooling portion of the drop tube furnace, wherein, after cooling, the particles have a substantially higher bulk density at room temperature than prior to delivering the particles to the inlet drop tube furnace.

12. The method of claim 10, wherein the step of cooling comprises cooling the particles as the particles traverse through a cooling portion of the drop tube furnace to provide a fused outer surface that reduces leachability of transition metal cations from the particles.

13. The method of claim 10, wherein the step of cooling comprises cooling the particles as the particles traverse through a cooling portion of the drop tube furnace to provide a non-porous fused outer surface.

14. The method of claim 10, further comprising forming, during the heating step, and retaining, during the cooling step, an internal void in each of at least a portion of the particles.

15. The method of claim 10, wherein, after cooling, the particles have an average aspect ratio of no more than 1.4.

16. The method of claim 10, wherein the delivering step comprises delivering the particles to a delivery system having an opening to a furnace chamber, wherein the delivery system is tapped to cause particles to drop through the opening.

17. The method of claim 10, wherein the delivering step comprises delivering the particles to a delivery system having an opening to a furnace chamber, wherein the delivery system comprises a rotatable disk disposed over and proximate to the opening, the method further comprising rotating the rotatable disk to cause particles to drop through the opening.

18. The method of claim 10, wherein the delivering step comprises delivering the particles to a delivery system having an opening to a furnace chamber, wherein the delivery system comprises a rotatable disk disposed beneath and proximate to the opening, the method further comprising rotating the rotatable disk to cause particles to drop into the furnace chamber.

19. An apparatus for spherulizing slag and ash particles, the apparatus comprising:
a delivery system to deliver the particles for heating;
a drop tube configured and arranged so that the particles from the delivery system drop through the drop tube;
at least one heating element disposed proximate the drop tube to heat the particles dropping through the drop tube, the at least one heating element being configured and arranged to heat the particles to a temperature where the particles form spheres;
an outlet duct coupled to the drop tube to receive particles from the drop tube, the outlet duct retaining a substantial amount of heat from the drop tube; and
a cooling zone to receive particles from the outlet duct and configured and arranged to allow the particles to cool prior to collection to reduce agglomeration of the particles.

20. The apparatus of claim 19, wherein the outlet duct is configured and arranged to radiate heat back into the drop tube.
